(19) United States
(12) Patent Application Publication
(10) Pub. No.: US 2011/0288910 A1
(43) Pub. Date: Nov. 24, 2011

(54) METHODS AND APPARATUS FOR THE ACQUISITION AND EXCHANGE OF MEDIA CONTENT IN COMMUNICATIONS NETWORK

(76) Inventors: Anuj Garg, San Diego, CA (US); Gregory Michael Verioti, San Diego, CA (US); Elaine Wilhemia Lutjens, Escondido, CA (US)

(21) Appl. No.: 13/042,291

(22) Filed: Mar. 7, 2011

Related U.S. Application Data
(60) Provisional application No. 61/346,432, filed on May 19, 2010.
(60) Provisional application No. 61/346,467, filed on May 20, 2010.
(60) Provisional application No. 61/361,473, filed on Jul. 5, 2010.

(51) Int. Cl. G06Q 30/00; G06F 15/16

(52) U.S. Cl. 705/14.1; 705/26.41; 705/26.1; 709/219

(57) ABSTRACT

Methods and apparatus for acquisition and exchange of media content. In one embodiment, the apparatus and methods facilitate selling and buying of content. A broker accepts content submitted by a content source and makes it available for sale to buyers. In another embodiment, the methods and apparatus also provide pricing reduction services as a function of time. The content owner is able to price their media content with pre-selected (or user entered) parameters which allow the sale price of the media content to automatically change at predetermined time intervals. In another embodiment, the methods and apparatus enable selling and buying editing services using the broker. The broker enables the secure exchange of media content between the editor and the customer (a content source or buyer) to enable editing services for the media content. The content source, content buyer and content editor may communicate with one another through the broker platform.

### PRIORITY RELATED APPLICATIONS

This application claims priority to co-owned, co-pending U.S. Provisional Patent Application Ser. Nos. 61/346,432 filed on May 19, 2010 and entitled “PROCESS FOR SELLING AND BUYING NEWS CONTENT IN A NETWORKED MARKETPLACE”, 61/346,467 filed on May 20, 2010 and entitled “METHOD FOR REDUCING THE SALE PRICE OF MEDIA CONTENT WITH THE PASSAGE OF TIME”, and 61/361,473 filed on Jul. 5, 2010 and entitled “PROCESS FOR SELLING AND BUYING EDITING SERVICES FOR MEDIA CONTENT IN A NETWORKED MARKETPLACE”, each of which is incorporated herein by reference in its entirety.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE INVENTION

1. Field of Invention

The present invention relates generally to the field of media content and/or data acquisition and exchange. More particularly, the present invention is related in one exemplary aspect to apparatus and methods for enabling the upload, sale, purchase, and editing of current events and other news-related material in a communications network.

2. Description of Related Technology

Traditionally, news and other media content is provided to consumers from network controlled (owned/operated) media sources (such as e.g., FOX®, ABC®, CBS®, NBC®, etc.). It is also traditionally true that in many instances, these media sources generate the content internally using hired professionals.

However, as new technologies emerge, these may also be deployed as new avenues for providing news and other media content to consumers. For example, via the Internet, consumers may retrieve information regarding current events, other people's viewpoints, media clips, etc. Still further, the proliferation of various consumer devices for capturing, creating, editing, and transmitting media content have also supplemented the traditional media content delivery platforms. The nature of the Internet as a public forum, and the ease with which these consumer devices may be used, enables non-professional users to generate and distribute media content themselves.

Traditional media outlets have begun providing opportunities for consumer comments, media clips, and information to be provided to the media source's mainstream audience by incorporating these into broadcasts, so-called “webisodes”, etc. For example, a person at the scene of a news-worthy event who has use of a consumer device (e.g., a cellular telephone camera, video camera, sound recorder, etc.) for capturing the event or otherwise commenting on the event may do so via the device, and have his/her comments, clips, etc. provided in a “special report” or even in a “breaking news” clip from a media outlet. However, in most instances the generators of the media content are not compensated for their contribution.

With respect to print or readable media (such as Internet news and entertainment sources), traditionally content was provided by hired professionals. However, there is movement in the field toward a more freelance system of content contributions. While these professional and freelance contributors are compensated, there exists no streamlined system for a media outlet to request and receive content on a given topic, from a particular viewpoint, etc., especially in a time-sensitive manner.

Accordingly, what are needed are methods and apparatus to enable users to upload media content (such as e.g., to a centralized server) for the use thereof by media outlets. Such use would ideally result in compensation or other consideration being provided to the user that provided the content.

Additionally, the exemplary methods and apparatus would enable a media outlet to search for particular content in an efficient manner, as well as to place a request for particular content to be filled by one or more users of the system (at or by a particular time, if desired).

### SUMMARY OF THE INVENTION

The present invention addresses the foregoing needs by disclosing, inter alia, apparatus and methods for acquiring and exchanging media content in a communications network.

In a first aspect of the invention, a method for exchanging of media content via a network is disclosed. In one embodiment, the method comprises: uploading media content from a content source to a media content server associated with a content broker; making the media content available for acquisition by one or more media content acquirers; receiving a selection of the media content from at least one of the one or more media content acquirers; and providing the media content thereto.

In a second aspect of the invention, a non-transitory computer readable apparatus having a storage medium and being adapted to store at least one computer program thereon is disclosed. In one embodiment, the at least one computer program enables the exchange of content in a network, the computer program being configured to, when executed: process the content uploaded from a user device, the content comprising content generated by a user of the user device; provide an interface for enabling at least one of a plurality of content buyers to select the content for purchase; provide a mechanism for receiving payment from the at least one of the plurality of content buyers in exchange for providing the content thereto; and divide the payment into at least first and second portions, the first portion distributed to the user, and the second portion distributed to a content broker. The broker comprises e.g., an entity maintaining the computer readable apparatus in association with a networked server.

In another embodiment, the at least one computer program enables the adjustment of a sale price of purchasable content as a function of time, the computer program configured to, when executed: receive a plurality of parameters for pricing of the content from a user which generated the content; utilize the plurality of parameters to calculate a sales price of the content, the sales price being based at least in part on a time during which the content has been offered for sale; and offer the content for sale to at least one buyer at the sales price.

In yet another embodiment, the at least one computer program provides media content editing services over a network, the computer program being configured to, when executed: identify one or more editing service providers providing editing services applicable to an individual one of a plurality of media content; enable a user to select at least one of the one or more editing service providers with respect to the individual one of the plurality of media content; provide the individual one of the plurality of media content to the selected at least one of the one or more editing service providers; distribute at least a portion of payment for the media content editing services to the selected at least one of the one or more editing service providers; and distribute an edited version of the media content, the edited version being processed by the selected at least one of the one or more editing service providers.

In a third aspect of the invention, a method of providing price adjustments is disclosed. In one embodiment, the adjustments of sales price are as implemented a function of time, the method comprising: receiving the content from a first user; receiving at least one parameter from the first user for the pricing of the content, the at least one parameter indicating at least one time interval during which the content may be offered for sale at a sales price before a price reduction is enacted; offering the content for sale to second users at the sales price; after expiration of the time interval: performing the price reduction; and offering the content for sale to the second users at a second price which is reduced from the sales price.

In a fourth aspect of the invention, a method of providing media content editing services over a network is disclosed. In one embodiment, the method comprises: uploading media content from a media content source to a media content server associated with a media content broker for the sale thereof; identifying one or more media content editing service providers providing media content editing services applicable to the media content; receiving a selection of at least one of the one or more media content editing service providers; providing the media content to a selected one of the one or more media content editing service providers for editing thereof; and establishing an account for holding payment for the media content editing services. Upon completion of the editing of the media content, at least a portion of the payment is released to the selected one of the one or more media content editing service providers; and the edited media content is provided.

These and other aspects of the invention shall become apparent when considered in light of the disclosure provided herein.

### BRIEF DESCRIPTION OF THE DRAWINGS

FIG. 1 is a block diagram illustrating one embodiment of a network architecture for acquiring and exchanging media content via a communications network according to the invention.

FIG. 2 is a logical flow diagram illustrating an exemplary embodiment of a method of enabling media content acquisition and exchange according to the invention.

FIG. 3 is a logical flow diagram illustrating an exemplary embodiment of a method of enabling a content purchaser to establish an account for content acquisition and exchange according to the invention.

FIG. 4 is a logical flow diagram illustrating an exemplary embodiment of a method for completing a purchase of media content according to the invention.

FIG. 5 is a logical flow diagram illustrating one specific implementation of the method of FIG. 2.

FIG. 6 is a logical flow diagram illustrating an exemplary embodiment of a method of enabling a content seller to establish an account for content acquisition and exchange according to the invention.

FIG. 7 is a logical flow diagram illustrating an exemplary embodiment of a method of enabling a sale price of media content to be reduced as a function of time according to the invention.

FIG. 8 is a logical flow diagram illustrating one specific implementation of the method of FIG. 7.

FIG. 9 is a logical flow diagram illustrating an exemplary embodiment of a method of enabling an editor service provider to establish an account for media content editing services according to the invention.

FIG. 10 is a logical flow diagram illustrating an exemplary embodiment of a method of providing editing services for media content according to the invention.

FIG. 11 is a logical flow diagram illustrating one specific implementation of the method of FIG. 10.

FIG. 12 is a block diagram illustrating an exemplary embodiment of a media content source entity in accordance with the present invention.

FIG. 13 is a block diagram illustrating an exemplary embodiment of a media content buyer entity in accordance with the present invention.

FIG. 14 is a block diagram illustrating an exemplary embodiment of a media content editor entity in accordance with the present invention.

FIG. 15 is a block diagram illustrating an exemplary embodiment of a broker entity in accordance with the present invention.

All Figures © Copyright 2010-2011 News Application, Inc. All rights reserved.

### DETAILED DESCRIPTION OF THE INVENTION

Reference is now made to the drawings wherein like numerals refer to like parts throughout.

As used herein, the term “application” refers generally to a unit of executable software that implements certain functionality. The unit of executable software generally runs in a predetermined environment.

As used herein, the term “broker” is meant to refer without limitation to an entity which accepts media content submitted by a media content owner(s), and makes the content available for acquisition (e.g., purchase) by the media content buyer(s). The broker may also facilitate the provision of editing services by editing service provider(s).

As used herein, the terms “buyer” and “purchaser” refer without limitation to individual(s) or entities that can obtain the rights to publish or own the copyright of the content.

As used herein, the terms “content” and “media content” are used to refer without limitation to text, still picture, video, audio, and/or any combination of these forms of content.

As used herein, the term “computer program” or “software” is meant to include any sequence or human or machine cognizable steps which perform a function. Such program may be rendered in virtually any programming language or environment.

As used herein, the terms “content owner” and “content source” are used to refer without limitation to an entity which generated or captured the content (such as by digital video and/or audio recording, typing, etc.). The content owner retains ownership of e.g., the copyrights to the content, or may transfer these to a purchaser.

As used herein, the terms “editing service provider” and “editor” are used to refer without limitation to individual(s) or entities which offer services related to the editing of content. Editor services may include photo editing, proofreading, audio/sound editing, media clip or video editing, etc. Editing services may be e.g., purchased by a content owner prior to the sale of content to one or more buyers. Alternatively, the editing services may be purchased by a content buyer after the purchase of content.

As used herein, the terms “Internet” and “internet” are used interchangeably to refer to inter-networks including, without limitation, the Internet.

As used herein, the terms “microprocessor” and “digital processor” are meant generally to include all types of digital processing devices including, without limitation, digital signal processors (DSPs), reduced instruction set computers (RISC), general-purpose (CISC) processors, microprocessors, gate arrays (e.g., FPGAs), PLDs, reconfigurable compute fabrics (RCFs), array processors, and application-specific integrated circuits (ASICs). Such digital processors may be contained on a single unitary IC die, or distributed across multiple components.

As used herein, the term “network”, refers generally to any type of telecommunications or data network including, without limitation, telco networks, and data networks (including MANS, WANs, LANs, WLANs, internets, and intranets).

As used herein, the term “network interface” refers to any signal or data interface with a component or network including, without limitation, those of the FireWire (e.g., FW400, FW800, etc.), USB (e.g., USB2), Ethernet (e.g., 10/100, 10/100/1000 (Gigabit Ethernet), 10-Gig-E, etc.), MoCA, Coaxsys (e.g., TVnet™), radio frequency tuner (e.g., in-band or OOB, cable modem, etc.), Wi-Fi (802.11a,b,g,n), WiMAX (802.16), PAN (e.g., 802.15), or IrDA families.

As used herein, the terms “purchase”, “sale”, and “buy” are meant to include without limitation obtaining the rights to publish or otherwise use copyrighted content. In some instances, these rights are not exclusive, and the content may be sold to or purchased by additional entities for subsequent and/or simultaneous use thereof. The copyright for the content may remain with the content source or may be transferred to a purchaser thereof.

As used herein, the terms “user device” and “client device” include, but are not limited to, personal computers (PCs), and minicomputers, whether desktop, laptop, or otherwise, and mobile devices such as handheld computers, PDAs, personal media devices (PMDs), and smartphones.

As used herein, the term “server” refers to any computerized component, system or entity regardless of form which is adapted to provide data, files, applications, content, or other services to one or more other devices or entities on a computer network.

As used herein, the term “storage device” refers to without limitation computer hard drives, memory, RAID devices or arrays, optical media (e.g., CD-ROMs, Laserdiscs, Btu-Ray, etc.), or any other devices or media capable of storing content or other information.

### Overview

The present invention discloses, inter alia, methods and apparatus for acquiring and exchanging media content via a communications network.

In one embodiment, the apparatus and methods are utilized to facilitate the selling and buying of news-related content. A broker accepts news content submitted by a news content source, and makes it available for transfer (e.g., sale) to a news content acquirer. Prior to the sale of the news content, the content source may select from a menu of options which define the method(s) of transferring or selling the news content. These options may include e.g., setting a starting sale price and a minimum sale price for the news content. The broker displays the news content items to at least one potential acquirer.

In another embodiment, the methods and apparatus are utilized to provide pricing reduction services for the sale of media content. The broker accepts media content submitted by the media content source, and makes it available for purchase to the media content buyers. The content owner is able to price their media content with pre-selected (or user entered) parameters, which allow the sale price of the media content to vary; e.g., automatically change at predetermined time intervals.

In yet another embodiment, the methods and apparatus are utilized for selling and buying editing services by content editor and content buyer or content creator using the broker. Media content is loaded onto the broker platform by the content creator (or agent thereof) or purchased by a content buyer. The creator and/or buyer may then select from a menu of options on the broker platform to choose editing services. Once the creator and/or buyer makes selections for editing services, the broker enables the secure exchange of media content between the editor and the creator and/or buyer. In one variant, the editor may establish a contract with the broker, and establish pricing with the creator and/or buyer for the editing services it offers.

The content source, content buyer, and content editor may communicate with one another through the broker platform.

### DETAILED DESCRIPTION OF EXEMPLARY EMBODIMENTS

### Network—

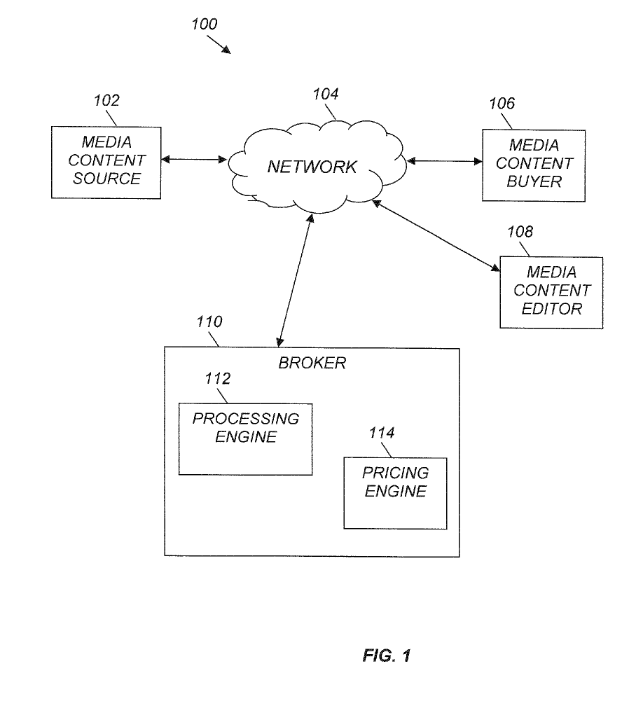

FIG. 1 illustrates an exemplary embodiment of a network architecture for acquiring and exchanging media content via a communications network. The media content may comprise for example text, still picture, video, audio, and/or any combination of these forms of content. As shown, the architecture generally comprises a media content source 102 in communication with a broker 110 via a communication network 104. A media content buyer 106 and editor 108 are also in communication with the broker 110 via the network 104. As will be discussed in greater detail below, the broker 110 enables exchange and acquisition of media content between the media content source 102, buyer 106 and editor 108. A simple architecture comprising one of each of the aforementioned components 102, 104, 106, 108, 110 is shown in FIG. 1 for simplicity, although it will be recognized that comparable architectures with multiple content sources 102, buyers 104, editors 108, and/or brokers 110 (as well as different network topologies) are readily implemented given the present disclosure, the illustrated embodiment being merely exemplary of the broader concepts of the invention.

The media content source 102 comprises user device which is utilized to generate media content. In one embodiment, the device (content source) 102 may comprise a consumer electronic device such as a mobile telephone/smartphone, audio/video recording device, digital camera, or a personal digital assistant. Still further, the content source 102 may comprise a handheld, laptop, personal, or portable computer. Literally any device capable of capturing, recording or generating media content including audio, video, 3D video, still pictures, moving pictures, and/or written (such as typed) words may be utilized as a content source 102.

In yet a further embodiment, the content source 102 may comprise a device or entity in communication with a device capable of capturing, recording or generating media content. For example, the content source 102 may comprise a personal computer which is in communication with a device for capturing audio/video sounds and images, such as e.g., a smartphone.

The content source 102 provides media content to the system to be acquired (e.g., purchased) by an acquirer (e.g., buyer) 106. The media content may be a news article, video clip, still images, etc. The content source 102 is owned and/or operated by a user which may be a professional or non-professional content creator. For example, the content creator may be a professional photographer, a non-professional who is present at a news-worthy event and captures images, audio/video, etc., an individual interested in pursuing journalism, etc.

The media content buyer 106 comprises a device owned and/or operated by an employee or agent of a media outlet. For example, the content buyer 106 may comprise a desktop computer or mobile device operated by an employee of a news media provider, such as CNN®. The content buyer 106 purchases content provided by the content source 102. As discussed in greater detail below, the content buyer 106 may further, via the herein-described system, submit requests for particular content and/or timing requirements to be met by the content source 102.

The media content editor 108 comprises a device owned and/or operated by an employee or agent of a content editor service. For example, the content editor 108 may comprise a desktop computer or mobile device operated by a particular employee of a proofing or editing company. The employee, as will be discussed below, provides editing services for the content provided by the content source 102 prior to its offer for sale to the content buyer 106. Editing services may include e.g., photo editing, film or audio/video editing, proofreading, etc. It is also noted that these editing services or processing may be substantially or fully automated if desired. For example, editing might simply comprise filtering or enhancing an image or video stream, which can be accomplished e.g., using one or more software applications.

The broker entity 110 comprises a device owned and/or operated by an employee or agent of an entity for providing brokerage services. For example, the broker entity 110 may comprise a server or series of computers managed by the brokerage firm for the purpose of acquiring and storing media content provided by the content source 102, and distributing the stored content. The broker entity further facilitates the exchange of content, such as for editing or purchase.

In one specific embodiment of the present invention, the exemplary network architecture of FIG. 1 is utilized for selling and buying news content using the broker 110. The content source 102 and content buyer 106 are in communication with the broker 110 via the network 104. In this instance, the broker 110 provides broker services for buying and selling of the news content. For example, the broker 110 may host a web site which allows the content source 102 and buyer 106 to conduct news content transactions (e.g., trading) as determined by selected parameters by the content source 102 and the broker 110. The transactions performed between the source 102, buyer 106 and broker 110 via the network 104 (e.g., the Internet) are facilitated by a processing engine 112. The processing engine 112 utilizes data input by the content source 102 and/or the content buyer 106 to generate a list of one or more news content items to be displayed to the buyer 106 for purchase. In some cases, the content source 102 and buyer 106 may communicate directly with the processing engine 112.

In another embodiment, the exemplary network architecture of FIG. 1 is utilized for enabling a broker 110 to use a pricing engine 114 to implement an algorithm for reducing the sale price of media content at predetermined time intervals. A media content source 102 and media content buyer 106, in this embodiment, communicate with the broker 110 through the network 104. In this instance, the broker 110 may comprise any entity that provides services for exchanging media content. For example, the broker 110 may host a web site which allows the content source 102 and buyer 106 to conduct news content trading. The sale price presented to the buyer 106 for media content at any given time is determined in one variant using a pricing engine 114. The pricing engine 114 utilizes data input by the content source 102 and the broker 110 to determine the price of the media content at any given time. Market-driven approaches may be used as well; e.g., such as where the pricing is in some way related or tied to a market index or one or more other metrics that help assess a “fair” price for the commodity.

In yet another embodiment, the exemplary architecture of FIG. 1 is utilized for selling and buying editing services using the broker 110. A media content editor 108 and media content source 102 are connected to the broker 110 through the network 104. The broker 110 provides broker services for the content source 102, and the editor service provider 108. For example, the broker 110 may host a web site which allows the content source 102 and the editor 108 to conduct a secure exchange of media content for the purpose of editing as determined by pre-set parameters selected by the content source 102 and the broker 110. The transactions performed between the content source 102, editor 108, and broker 110 are facilitated in one variant by a processing engine 112. The processing engine 112 utilizes data entered by both the content editor 108 and the content source 102 to match parameters set by the content source 102 with those of the content editor 108.

In a further embodiment, the editor 108 and content source 102 are in communication directly via to processing engine 112.

### Buying/Selling Methods—

Various ones of the steps of the methods disclosed herein are optional, or may be combined, or permuted in order, etc., and that the presence or absence of a step in any embodiment of a method described herein should not be considered limiting.

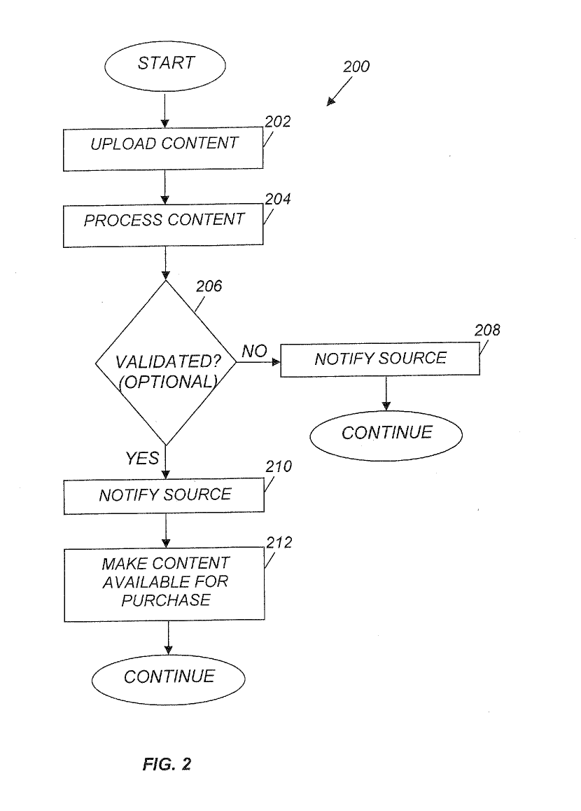

Referring now to FIG. 2, an exemplary embodiment of a method for enabling the buying and selling of media content is illustrated. Per step 202 of the method, media content is uploaded from a content source 102 to a storage entity associated with the broker 110. In one specific implementation, the media content is news content, although other types of media may be used with equal success.

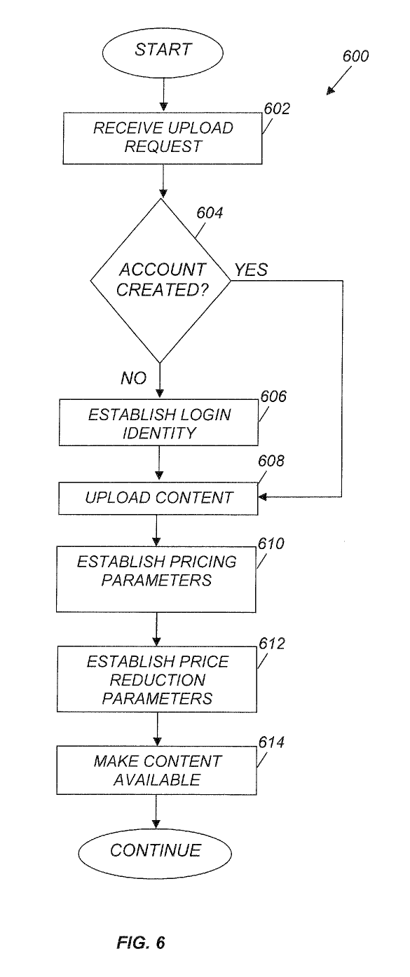

As will be discussed below (see e.g., FIG. 6), a content source 102 may establish an account prior to uploading content. Prior to the transfer or sale of the content, the content source 102 selects from a menu of options (or otherwise enters parameters) which define the method(s) of transferring the content, including for example (in the case of a sale) setting a starting sale price and a minimum sale price for the content. Other types of transfer may include barters, exchanges, loans or leases, etc. The content source 102 may further select a method of selling the content using e.g., menu options. For example, the content source 102 may select to sell the content openly or directly to selected buyers (such as those which have previously indicated an interest in such content). Still further, the content source 102 may elect to display the content item in a specific order to specified (e.g., preselected) ones of the potential buyers 106.

Hence, the content source 102 of the illustrated embodiment connects to the broker 110 through the network 104, selects the parameters that define the sale of the news (or other) content, and uploads the content to the broker 110.

Next, per step 204, the content is processed by the processing engine 112. In one embodiment, processing includes the processing engine 112 assigning a report or identification number to the content and a time stamp on the submission.

At step 206, the content is optionally validated. In one implementation, one or more entities at the broker 110 determine whether the content is suitable for submission to buyers 106 for purchase. For example, content which is illegal or pornographic, or which matches or copies other known copyrighted content (e.g., plagiarized), or which does not meet other criteria such as encoding type, length, format, etc., may not be validated at step 206. When content is not validated, per step 208, the content source 102 is notified including, in one variant, any relevant reasons why the content was not acceptable. However, if the content is validated, the content source 102 is notified (step 210), and the content is made available for purchase (step 212).

The content is made available to potential acquirers or purchasers 106 by e.g., providing an alert or other notification to certain purchasers when content of a particular type is newly made available. For example, a potential purchaser may be interested in media content regarding a breaking news event. The potential purchaser, in this instance, provides this parameter to the broker 110. Then, when content of the described type becomes available, the potential purchaser will be alerted to its availability, such as by email, instant/text message, message within the broker system (so that the alert received when the purchaser logs on to a server associated with the broker), etc.

In another alternative, a list of available content may be provided to potential purchasers upon login or viewing of the broker website. Newly validated content is presented in the list, in one embodiment, according to the date or time stamp assigned thereto during processing.

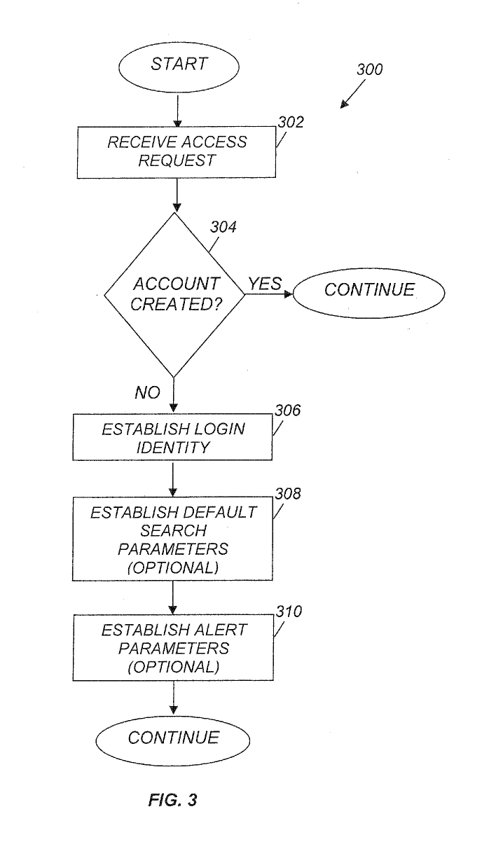

Referring now to FIG. 3 an exemplary method for establishing a media content purchaser or buyer 106 account with the broker 110 is illustrated. As noted above, in one embodiment, the content buyer 106 may establish an account and “log in” to the broker 110 before being provided with a listing of available media content for purchase. Accordingly, per step 302 a request to access the broker 110 site (including lists of available content) is received. Next, it is determined whether an account has been established for the requesting buyer 106. For example, the buyer 106 may be presented with an option to enter a login identity or may be provided a link to establish a new account. If an account has not already been created, the broker 110 enables the purchaser 106 to establish a login identity, such as a username and password combination at step 306.

Per step 308, the content buyer 106 may optionally establish default parameters for searching available content. For example, if the content buyer 106 often purchases written documents (as opposed to audio/video content), this may be selected as a default search parameter. In a further example, the content buyer 106 may select default parameters based on the subject matter of the content, the geographic location to which the content relates, a particular one or ones of content sources 102, etc. Each of these options is presented to the buyer 106 for creating a default search profile in the form of e.g., a series of web pages.

In another embodiment, default parameters include the buyer 106 establishing that content items should be displayed in a specific order, and/or limiting the number of items displayed.

Per step 310, the content buyer 106 may optionally establish default parameters for receiving alerts. For example, when a breaking news event occurs, the content buyer 106 may establish that it would like to receive updated media content on the subject as soon as it becomes available.

In yet another example, the content buyer 106 may establish as default alert parameters that it would like to receive alerts regarding any immediately available media content on e.g., natural disasters, terrorist acts, extreme weather conditions, etc.

In another embodiment, a particular buyer 106 with a very specific focus may require alerts regarding such things as celebrity sightings or entertainment announcements.

Geographic data may also be included with the content if desired; e.g., GPS coordinates, LAT/LONG data, etc. so as to give the potential buyer some geographic or location context regarding the source, where applicable.

In yet another embodiment, a computerized search engine (such as e.g., that developed by Microsoft Corporation of Redmond, Wash.,) may be used to search video content for context or particular phrases or keywords. Specifically, one such embodiment uses a speech recognition algorithm to “scan” through video clips so as to identify particular items of interest. This information may then be used to select content, select appropriate advertising to be packaged or displayed with the content, etc.

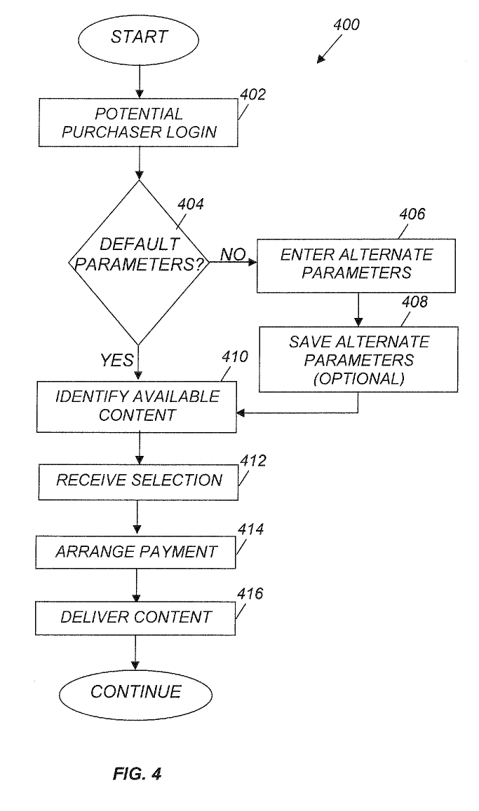

Referring now to FIG. 4, an exemplary method for completing the purchase of content is illustrated. As shown, per step 402, a potential purchaser 106 logs into the broker 110 site. The purchaser 106 may decide whether to proceed with previously entered default search parameters (see discussion above regarding account establishment and FIG. 3) at step 404. If the default search parameters will not be utilized, then, per step 406 alternate parameters are entered. These alternate parameters may optionally be saved to the buyer's profile at step 408.

If, at step 404, the default search parameters are to be utilized and/or once alternate search parameters have been entered (step 406), these are used by the broker 110 to identify available content meeting the searched criteria at step 410. The identified content is in one variant assembled in short form, such as in the form of a list, for presentation to the purchaser 106. The purchaser may then select (at step 412) that content which it would like to purchase.

At step 414, consideration (e.g., payment) for the purchased content is arranged. It is appreciated that in one embodiment the purchase price, once paid by the purchaser 106, is divided according to a predetermined schedule between the broker 110 and content source 102 (and optionally other entities where applicable, such as an intermediary or editing entity). Once the content has been purchased, it is provided to the purchaser 106 at step 416.

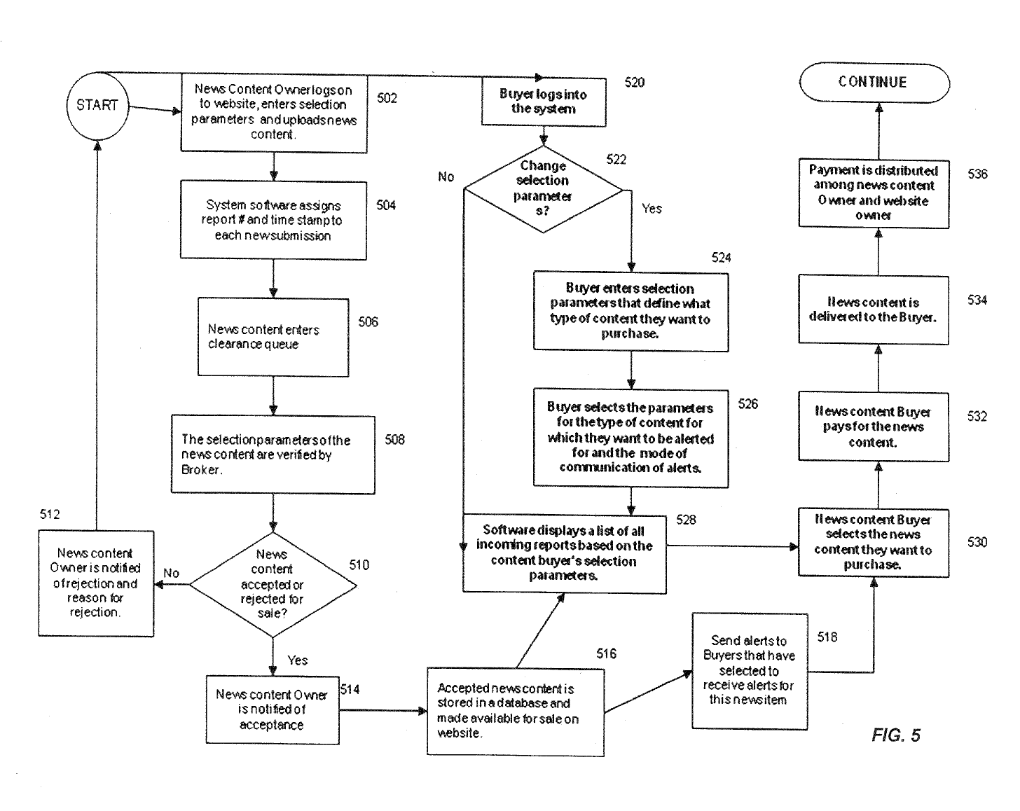

Referring now to FIG. 5, one implementation of the exemplary method of enabling media content acquisition and exchange according to FIG. 2 is illustrated. In particular, this implementation enables the buying and selling of news content over a network such as the Internet.

At step 502 the content owner (e.g., content source 102) connects to the broker 110 platform through network 104, selects the parameters that define the sale of the news content, and uploads the news content to the broker. A processing engine 112 assigns a report or identification number to the news content and a time stamp on the submission at step 504. At step 506 the news content is put in queue waiting for the verification process at step 508.

Suppose for example an individual has real time video of a plane in an emergency landing on a California freeway. Their phone is used to capture the video, and connect to the broker's 110 web site through a network 104 (e.g., cellular network, WiMAX or LTE network, Wi-Fi network, etc.). The individual assigns the parameters that define how they want the video to be transferred (e.g., sold). In this exemplary context, the individual also sets the sale price at start of sale and/or the minimum acceptable sale price. After the parameters are set, the video news content is uploaded on the broker 110 website. The processing engine 112 automatically generates the report or identification number, and assigns the date and time of the video submission. The video submission is put into queue before the selection parameters are verified.

At step 510, the news content is accepted for sale or rejected by the broker 110. If the content is rejected, at step 512, the news content owner 102 is notified of their rejected content and the reason for rejection. At step 514 the owner 102 is notified that their news content is accepted for sale. The news content is stored in a database and opened for sale on the broker's web site at step 516.

At step 518, an alert about the news content is sent to one or more news content buyers 106, such as e.g., based on parameters the news content buyer 106 set (see step 526). At steps 520-526 the news content buyer 106 connects with the broker 110 through the network 104. The news content buyer 106 has the option to change selection parameters that define the type of news content they want to obtain at step 522. At step 528, the system displays a list of all incoming or previously received reports based on the buyer's 106 selection parameters. At step 530, the buyer 106 selects the news content they want to purchase.

Continuing the example discussed above, the individual is notified that their breaking video coverage of the emergency plane landing was approved for sale by the broker. The news content buyer 106 is notified by the broker of the emergency plane landing video in this instance, because the buyer selected appropriate parameters such as e.g., “Category: Emergency—Disaster” and “Country: United States”. Other selection and/or filtering criteria such as offering price, latency/delay since obtained, etc. may also be specified by the prospective buyer.

The processing engine 112 presents a preview of the video on the buyer's 106 device as an option to purchase, in one embodiment. The plane landing video content may then be selected by the buyer 106 to be purchased.

At step 532, the buyer 106 agrees to the terms of sale as set by the broker 110 and content owner 102, and pays the broker 110 for the news content.

At step 534, the news content is then delivered to the buyer 106.

At step 536, the payment received from the buyer 106 is distributed between the owner 102 and broker 110 using the processing engine 112.

### Price Reduction Methods—

Conventionally, rights to publish or own the media content are often sold at a fixed price, included as a part of an organizational membership or at a bidding auction that includes a limited number of buyers. Some of the media content, especially news content, is very time sensitive and its perceived value for the buyer decreases with time. Prior art systems do not address this feature.

Referring now to FIG. 6, exemplary method of enabling a content seller to establish an account for content acquisition and exchange is illustrated. The method of FIG. 6 advantageously provides for the automatic adjustment of the sale price of the media content with time, so that the actual value of the media content can align with the perceived value, thereby addressing the foregoing deficiency of the prior art.

As shown, per step 602, a request to upload content to the broker 110 is received. The content source 102 requests to upload content via an interface or webpage maintained by the broker 110. It is then determined whether the content source 102 has an account with the broker 110 (step 604). This may be determined by e.g., providing an opportunity for a user at the content source 102 to enter a login identity. If an account has not been created, per step 606, the content source 102 (or user thereof) may be provided an opportunity to establish a login identity, such as by establishing a user name and password. Once the login identity has been established (i.e., the content source's account created) and/or if an account already exists, per step 608, the content source 102 may upload the content to storage associated with the broker 110.

For each piece of uploaded content, the content source 102 of the illustrated embodiment provides pricing parameters (step 610) and price reduction parameters (step 612). The pricing parameters include, for example, a starting price and a minimum price. The starting price represents the first and highest price at which content is offered for sale. The minimum price represents the lowest price at which the content is offered for sale. The price reduction parameters include time intervals and percent decrease at each interval and/or the fixed amounts by which a price is to be reduced. In other words, the price reduction parameters indicate how often and by how much the sale price of uploaded content may be reduced.

While a substantially linear schedule (i.e., same temporal increments and same percent decrease at each increment) is shown in the illustrated embodiment, it will be appreciated that any number of different schedules (linear or non-linear, step-wise, discontinuous, etc.) for both pricing and/or time may be used consistent with the invention.

In one embodiment, a potential buyer may be made aware of the lowest price content may made available at and the approximate date/time it will be available at that price.

In an alternative embodiment, default pricing and price reduction parameters may be established during account setup. These default parameters may be selected by the content source 102 when uploading content, or alternate parameters may be entered. Providing a means for enabling default parameters makes uploading content simple and requires fewer steps, thereby facilitating direct uploading of content from e.g., a mobile device.

The uploaded content is processed and validated as noted above. Then, per step 614, the content is made available to potential purchasers. In one embodiment, this may include providing the content in a list of available content, and/or providing alerts to one or more potential purchasers 106 regarding the availability of the content.

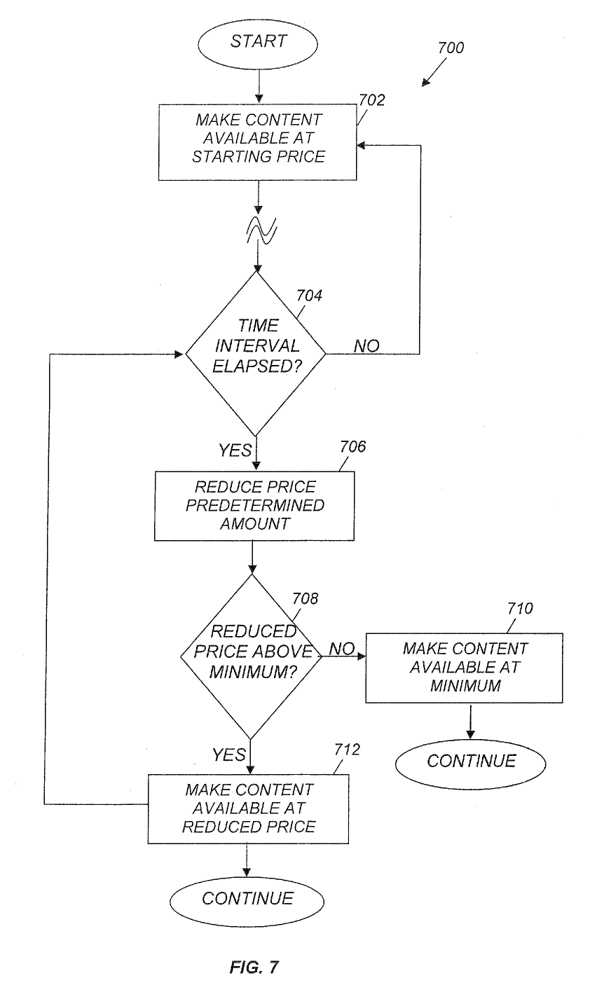

Referring now to FIG. 7, an exemplary method of enabling a sale price of media content to be reduced as a function of time is illustrated. As shown, per step 702, content is made available for purchase at a starting price. As discussed previously, the starting price is established at the time of content upload (either by manual entry or selection of default pricing parameters), or may be established in advance of upload, or even dynamically as a function of one or more external parameters.

After the time interval established at content upload (see discussion above) elapses (step 704), the price is reduced by a predetermined or dynamically determined amount (step 706). The amount by which the price is reduced is given by the parameters established at content upload, or as a function of time-varying parameters or factors such as e.g., prevailing market conditions, number of other competing content elements from other sources, etc.

In a further embodiment, however, the price reduction interval and amount may be established by the broker 110. Likewise, the minimum and starting prices of media content may also be established by the broker 110. For example, the broker 110 may base pricing structure and/or reduction parameters on the type of content (audio/video, documents, still pictures), content source 102 (such as by a ranking of the quality of previous posts), newsworthiness of the content, or other factors. In a still further embodiment, the broker 110 may set outside limits (maximum and minimum) for content prices, which the user (content source 102) may use as a guide for setting pricing parameters and/or reduction parameters.

At step 708, it is determined whether the reduced price is above the minimum price established for the content. If it is not, the content is made available at the minimum price (step 710). Content which does not sell after a predetermined period may be removed from the available content listing at the broker 110. Alternatively, it may remain at the minimum price indefinitely.

If however, the content reduced price is above the minimum price, it is provided for sale at the reduced price per step 712. The method continues back to step 704 where, after a time interval elapses additional reductions are made until the minimum price is met, or the content is no longer available, i.e., has sold or is otherwise removed.

In one embodiment, once sale price for the media content reaches the minimum acceptable price, it continues to remain for sale at that minimum price indefinitely without any further price reductions or until the content owner 102 determines a new sale price for the media content.

In yet another embodiment, the herein-described methods for the reduction of the sale price continue regardless of the number of sales for the same media content. That is to say, although the media content has sold once, it remains available for sale and, at appropriate times the price for the content is reduced. Alternatively, after a first sale of content, the price may be immediately reduced, then later reduced again according to the time intervals established for the content.

Still further, in another embodiment, the content broker 110 may be given an option to change the price parameters at any time if it appears the content is not selling at the predetermined price. Such price changes may occur with or without the consent of content owner 102. The content owner 102 may be provided an option to stop the sale price reduction, and/or change the sale price parameters at any time as well.

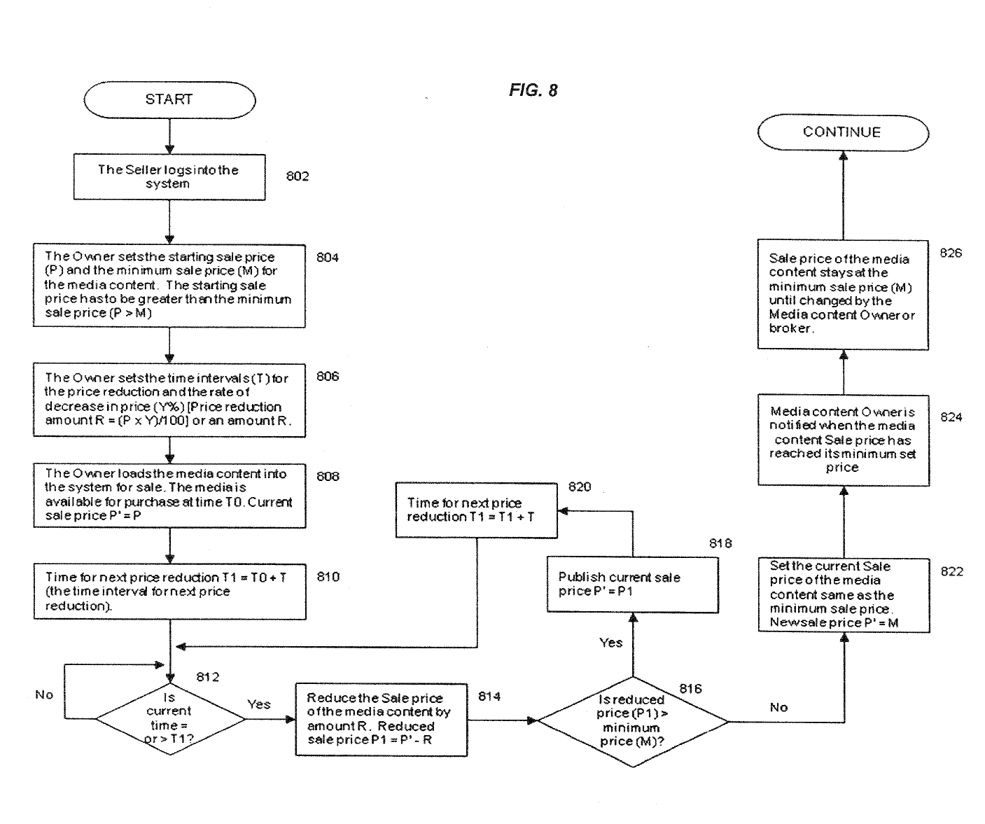

Referring now to FIG. 8, a logical flow diagram of an exemplary process for reducing the sale price of media content with the passage of time is provided. At step 802, the owner of the media content (e.g., content source 102) connects to the broker 110 and selects the parameters that define the method(s) of sale of the media content. If the content owner 102 chooses the method where the sale price of the media content reduces with the passage of time, the owner 102 sets the starting sale price, P, and the minimum sale price, M, for the media content at step 804. In one embodiment, the system will not allow the owner 102 to set the starting sale price of the media content to be equal to or less than the minimum acceptable sale price. In other words,

P>M Eqn. (1)

At step 806, the owner 102 sets the time intervals, T, after which the price reduction will occur and the rate of decrease in price, Y, as a percent of the starting sale price, or an amount, R. If the owner 102 selects the rate of decrease of price reduction, Y, then R is calculated as:

R=(Y*P)/100 Eqn. (2)

At step 808, the owner 102 loads the media content into the broker's 110 platform for sale. The media content is available for purchase starting at time T₀, which is selected by the owner 102. Alternatively, T₀ may be a default setting occurring as soon as the pricing engine 114 can process the request. The current sale price, P′, is set to the starting sale price, P. At step 810, the pricing engine 114 calculates the time for next scheduled price reduction, T₁, by adding the time interval, T to the starting time, T₀ (i.e., the time at which the media content was initially made available for sale to the buyer 106).

The pricing engine 114 checks at regular intervals if the current time is equal to or greater than the time for next price reduction, T₁, at step 812. As soon as the current time is equal to or greater than the time for next price reduction, T₁, the sale price of the media content is reduced by amount R by the pricing engine at step 814. The reduced sale price, P₁, is now equal to the previous sale price minus the amount R.

At step 816, the pricing engine 114 evaluates whether the reduced sale price, P₁, is greater than the minimum acceptable sale price, M, set by the content owner. If the reduced sale price, P₁, is greater than the minimum set sale price, M, the current sale price, P′, is set equal to the reduced sale price, P₁, at step 818. The time for the next scheduled price reduction, T₁, is calculated by adding the time interval, T, to the current value of T₁, the time of the most recent price reduction at step 820. The pricing engine 114 continues to check at regular intervals whether the current time is equal to or greater than the time for next price reduction, T₁, per step 812.

At step 816, if the pricing engine 114 determines that the reduced sale price, P₁, is less than or equal to the minimum acceptable sale price, M, set by the content owner 102, the current sale price, P′, is set equal to the minimum acceptable sale price, M, at step 822. The content owner 102 is notified using email, messaging, texting, paging or any other means of communication that the media content sale price has reached its minimum set price (step 824). Then, per step 826, the sale price of the media content stays set at the minimum acceptable sale price, M, indefinitely or until changed by the owner 102 or the broker 110, or until the content is sold.

Suppose for example that a content owner 102 connects with the broker 110 at step 802 to sell the rights to publish his breaking news article about an oil spill off the coast of California. He sets the starting sale price, P, for the rights to publish the news article at $1000 and the minimum acceptable sale price, M, at $250 at step 804. At step 806, the owner 102 sets the time interval, T, for the price reduction at one hour and the rate of decrease in price, Y, at 10% of the starting price. After each hour from the previous price reduction, the sale price for rights to publish the news article will change by amount, R, equal to $100 ($1000×10)/100).

At step 808, the content owner 102 loads the article about the oil spill into the broker's 110 system for sale. Assume that the media is available immediately for purchase at time, T₀, equal to 10:00 A.M. at the current sale price, P′, equal to $1000.

At step 810, the pricing engine 114 calculates that the time for next scheduled price reduction, T₁, is 11:00 A.M. (by adding one hour to starting time 10:00 A.M.). Thus, at 11:00 A.M., the sale price for the rights to publish the news article is reduced by $100 by the pricing engine 114 at step 814. The reduced sale price, P₁, is now equal to $900 ($1000-$100). Per step 816, the pricing engine 114 evaluates whether the reduced sale price of $900 is greater than the minimum acceptable sale price of $250. In this case P₁ is greater than M and therefore the current sale price, P′, is set equal to $900 at step 818.

The time for the next scheduled price reduction, T₁, is now set at 12:00 P.M. by adding one hour to the time of the most recent price reduction (11:00 A.M.) at step 820. At 12:00 00 P.M., the sale price for the rights to publish the news article is reduced by $100 by the pricing engine 114. The reduced sale price P1 is now equal to $800.

The sale price for the news article will continue to decrease after each hour until the reduced sale price reaches the value of $200 (at 6:00 00 P.M. of that same day). At that point, the reduced sale price of $200 is no longer greater than the minimum acceptable sale price of $250. In this case P₁ is less than M, and, therefore, the current sale price, P′, is set equal to the minimum acceptable sale price of $250 at step 822.

The owner 102 is then notified that the sale price for the news article has reached $250 (step 824). Per step 826 the sale price of the news article stays set at $250 indefinitely.

As previously noted, the methods described herein may readily be adapted to dynamically changing values of the time intervals, T, for the price reduction and/or the rate of decrease in price, Y, based on certain algorithms. In other words, each time interval may have a different rate of decrease associated therewith. Furthermore, although the sale price described herein is one singular price for all transactions, in reality the price may also be a function of other parameters including the number of copies bought by the buyer 106, the length or complexity of the content, the circulation of the publications sold by the buyer 106, the latency of when the news was “captured” as compared to when the event of interest took place (to be distinguished from the latency or time that the content has been available), etc.

### Editing Feature Methods—

The methods discussed herein include providing an entity (e.g., the broker 110) which allows content creators and/or buyers to select editing services for their media content from a menu of options. The media content editing service(s) are provided by a media content editor 108. In one embodiment, the editor 108 is an individual(s) or entity (including a substantially automated and computerized entity such as a server) that offers services in any area of expertise related to the editing of media content. The customer of editing services (which may be a content creator and/or buyer; hereinafter collectively referred to as “customers”) are any individuals or organizations that seeks editing services for media content. In one embodiment, the customer may be a content generating entity (such as the content source 102), or an entity which has purchased media content (such as the content buyer 106).

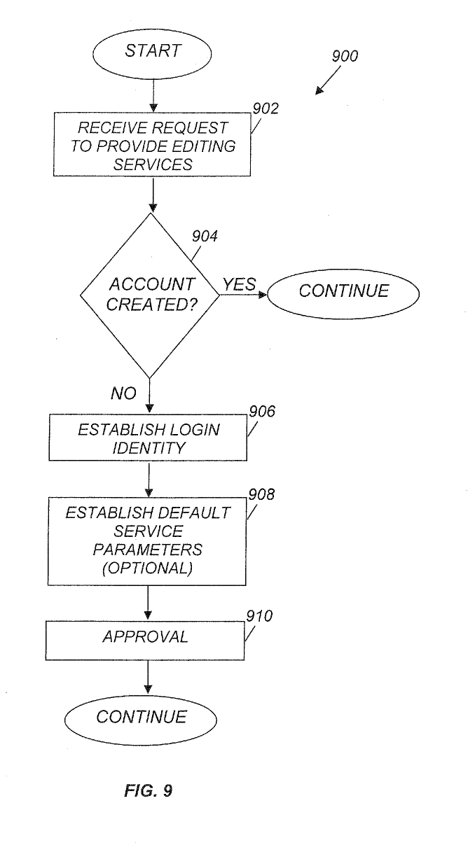

Referring now to FIG. 9, an exemplary method for enabling an editor service provider 108 to establish an account for providing editing services for media content is described.

As shown, per step 902, a request is received to provide editing services. If an account has been previously created for the media content editor 108 (step 904), then the method continues. This may be determined by the media content editor 108 being offered an opportunity to log in to the broker 110 site and the editor 108 entering appropriate login information.

If an account has not been created, then per step 906, a login identity for the editor 108 is established. In one embodiment, the login identity may include e.g., a password and user name combination unique to the editing service provider 108.

Default parameters for the services provided by the media content editor 108 may be optionally established at step 908. Default parameters may include the types of services provided and prices for these services.

At step 910, the broker 110 approves the editor 108 as a provider through the broker 110 site. In one embodiment, approval may be dependent on the editor 108 meeting certain criteria, agreeing to terms and conditions of the broker site, etc.

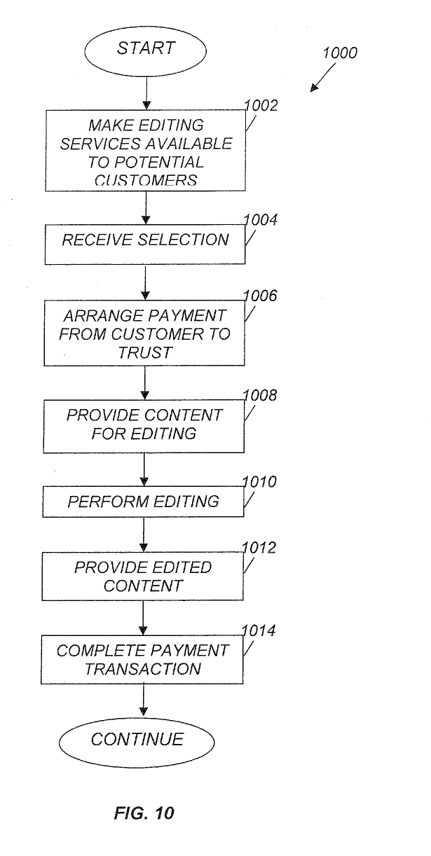

FIG. 10 illustrates an exemplary embodiment of a method for providing editing services for media content according to the present invention.

As shown, per step 1002, editing services are made available to potential customers (e.g., content sources 102 or content buyers 106). In one embodiment, editing services are advertised such as on the broker 110 site, so that the content sources 102 and/or content buyers 106 may be made aware that such services are available. Alternatively, a notification may be presented to a content source 102 when content is uploaded and made available for purchase, indicating that editing services are available. The notification may specifically identify certain ones of editing service providers (such as those who have paid a premium for identification at this stage, which may also be “ranked” in terms of prominence or the like if desired).

In yet another alternative, a notification may be provided prior to completion of a purchase by a content buyer 106 advertising editing services.

Next per step 1004, a selection of particular editing services is received. The selection may specifically indicate a particular content editor 108 or alternatively may indicate merely requested services. The broker processing engine 112, may then utilize the service request to identify one or more media content editors 108 which are capable of providing the requested services. The content source 102, the buyer 106, or the broker 110 may make a selection of a particular content editor 108 capable of providing the requested services.

Payment is arranged at step 1006 from the customer (content creators and/or buyer) to a trust account held by the broker 110. This may include, for example, an electronic payment made from an account associated with a service purchaser (such as a content source 102 or buyer 106) to an account maintained for the selected editor 108 by the broker. The herein-described accounts may comprise e.g., bank accounts managed by national and internationally recognized banking authorities. Alternatively, well known PayPal® accounts or the like may be utilized. In a still further embodiment, users may establish an account managed and maintained by the broker 110. Money or other credits may be stored to a particular user (editor 108, source 102 and/or buyer 106) and utilize to buy and sell media content and editing services.

Once payment is arranged, the media content to be edited is provided to the media content editor 108 for editing (step 1008). The content may be passed between the entities in encrypted form, such as utilizing public-private key pair encryption. At step 1010 the media content editor 108 edits the provided media content. The edited content is then provided to the purchaser of the editing services (e.g., the content source 102 or content buyer 106) at step 1012. Then, per step 1014 the payment transaction is completed by moving the payment from trust to an account associated with the media content editor 108.

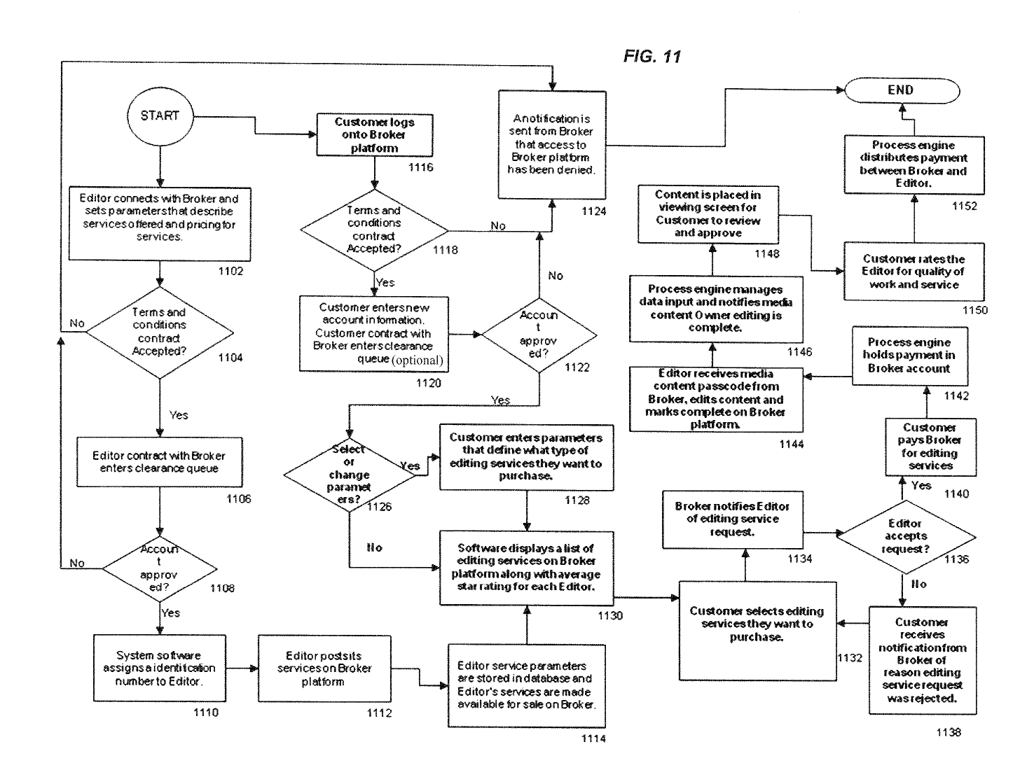

Referring to FIG. 11, a flow diagram of an exemplary process for selling and buying media content editing services using the broker 110 is provided.

At step 1102 the media content editor 108 connects with the broker 110 and sets parameters that describe its services offered, as well as pricing for its services. At step 1104, the broker 110 presents a terms and conditions contract between the editor 108 and the broker 110. If the editor 108 does not accept the terms of the contract set by the broker 110, then the editor 108 receives notification from the broker 110 that their request to access the broker's 110 platform has been denied at step 1124.

If the editor 108 accepts the terms of the contract, then the editor 108 is asked to provide other information, including bank account information that will be used to deposit service fees. The editor 108 account may then enter a clearance queue at step 1106. Once approved by the broker 110 at step 1108, the editor 108 is assigned an identification number at step 1110 and, at step 1112, the editor 108 posts its services on the broker 110 platform.

At step 1114, the parameters set by the editor 108 at step 1102 are stored in a database, and the editor's 108 services are made available for sale on the broker's 110 platform.

Suppose for example, ABC Editing Agency connects with a broker web site to advertise its editing services for journalists. ABC Editing selects from a menu of options on the broker website that identify its services as “Type: Journalism Article”, “Category: Politics”, and “Language: English (US)”, and lists its turnaround times ranging from 3 hours to 24 hours. ABC Editing also sets pricing parameters for its services based on e.g., the category of the article, and/or the turnaround time requested by the customer (content creator and/or buyer). After accepting the terms and conditions contract ABC Editing's request to post its services is put into a queue on the broker website. ABC Editing is provided a user identification number or other such indicia by the broker, and their services are made available for sale on the broker website.

At step 1116, a customer (such as e.g., a content source 102 or content buyer 106) logs onto the broker's 110 platform. The broker 110, at step 1118, presents a “terms and conditions” contract between the customer and the broker 110. If the customer does not accept the terms of the contract set by the broker 110, then the customer receives notification from the broker 110 that their request to access the broker's 110 platform has been denied at step 1124. If the customer accepts the terms of the contract, then the customer is asked to provide other information, such as e.g., credit or debit card information that will be used to pay service fees. The customer account then enters a clearance queue at step 1120.

If account is approved at step 1122, then at step 1126 the broker 110 offers the customer (such as e.g., a content source 102 or content buyer 106) the chance to select or change previously selected parameters that may define the type of editing services they need for their media content at step 1128.

At step 1130, the broker 110 software displays a list of available editing services and an average quality (e.g., “star” or similar) rating of each editor 108 based on parameters set by the customer (e.g., a content source 102 or content buyer 106) and the editor 108.

Suppose for example that a freelance journalist that has been investigating and reporting on the candidates for an upcoming California Gubernatorial election, and has connected with the broker web site mentioned, searches from a menu of options for an editing company that specializes in journalism articles that can have the article edited and returned by the following morning (12 hours). ABC Editing agency is provided as one of the available options to the journalist. According to this example, each service provider is given a rating within a system of up to five (5) stars. In this case the ABC Editing agency is shown to have an average rating of 4.5 stars.

At step 1132, the customer (e.g., a content source 102 or content buyer 106) selects the editing services they want to purchase. At step 1134, the broker 110 notifies the editor 108 of the editing service request from the customer. The editor is notified via email, phone, text, fax or any other means of communication of the editing service request. The editor may then connect to the broker platform, and have access to view media content.

At step 1136, the editor 108 accepts or rejects the request. If editing service request is rejected a notification is sent to the customer (e.g., a content source 102 or content buyer 106) of reason for rejection at step 1138. At step 1140, the editor 108 accepts the request, and the customer submits payment for editing services. Customer payment is held in the broker 110 account at step 1142.

At step 1144, the editor 108 receives a media content passcode from the broker 110, edits the media content, and marks the service as completed on the broker 110 platform.

Continuing the example above, ABC Editing is notified by the broker via email (or other notification service) of the editing service request from the freelance journalist. ABC Editing accepts the request by e.g., clicking on an “Accept” button in the email. An email is generated and sent to the broker and the freelance journalist that the editing service request has been accepted. The freelance journalist submits payment to the broker, which is placed into an escrow account until editing services are complete. The broker sends via email to ABC Editing the passcode or other cryptographic element (e.g., public/private encryption key) to access and edit the article.

At step 1146, process engine 112 manages data input from the editor 108, and notifies the customer (e.g., a content source 102 or content buyer 106) that the editing service request is complete. The media content is then placed in a viewing screen for the customer to review and accept at step 1148. As will be discussed in greater detail below, in one embodiment of the invention, once the customer accepts the content, the customer is asked to rate the editor 108 (for example, on scale of 1 (worst) to 5 (best)) based on various quality and delivery parameters at step 1150. The process engine 112 distributes payment between the broker 110 and the editor 108 at step 1152.

Still furthering the above example, within 8 hours of the request the freelance journalist receives an email (or other notification) that ABC Editing has completed the article. The media content is placed in a viewing screen on the broker website for the journalist to review. The journalist's payment is then released from the broker escrow account, and distributed to ABC Editing and the broker.

### Rating—

As noted above, in one embodiment, the services of a “rate” (e.g., content editor or even the content source) may be rated by a “rater” (e.g., the purchaser thereof or another entity, such as e.g., the ultimate consumer of the product). Many different paradigms or combinations of “rater” and “rate” are envisaged according to the present invention. For example, edited content provided by an editing service may be rated by the ultimate consumer of the content, whether such rating is provided directly by that consumer to the editor/source, or indirectly via a purchaser (such as a network who distributes the content to the ultimate consumer).

As another example, a content owner 102 may purchase services, and receive an edited version of the content. The owner 102 may then rate the quality of an editor's work (for example, on scale of 1 (worst) to 5 (best)).

The content and/or services may be rated based on various quality standards unique to the purchaser of the services, or provided by the system. Likewise, delivery of a finished product (including promptness, etc.) may be evaluated by the consumer of the editing services. The system may rank sources or editors based on their ratings, and/or give editors having higher rankings or ratings preference in being provided as editing options to potential customers.

In another embodiment, the seller of content (who may or may not be the content author or creator) may also be rated, such as by the content buyer 106. According to this embodiment, the quality of the content (i.e., audio/video quality, quality of text or other discussion, etc.) may be rated in a manner similar to that discussed above. Additionally, other metrics relating to the transaction (e.g., ease of processing, accessibility, etc.) may be rated. The rater's (e.g., seller's) rating may be performed for each individual piece of content submitted by the rate (e.g., content owner 102), such that subsequent purchasers are made aware of the quality of the content. Alternatively, or in addition, the content author or creator him/herself may be rated.

The ratings described herein may be provided according to various different schemes or periodicities. For example, in one approach, each time the content buyer 106 buys content from the broker site, a rating is submitted. An overall rating can be generated that is based on the aggregate rating of all the content submitted by the content owner. As noted above, the system may rank content sellers based on rating(s), and/or give preference to sellers having higher ratings.

In yet another embodiment, the content itself may be given a rating corresponding to its usefulness, truthfulness, quality, applicability to a given topic, coherency, logical flow, etc. Such a rating may be useful e.g., in the instance subsequent parties seek to purchase that same content.

In the example outlined above, the rating system may utilize a number system of e.g., 1 through 5 or the like. However, other rating systems may also be utilized, such as for example, descriptors (e.g., fuzzy logic variables such as “average”, “fair”, “poor”, “outstanding”, etc.), stars, etc. In yet another example, the rating system may be based on the rater's (e.g., the purchaser of editing services or the purchaser of content) answering a series of questions regarding the rated entity or content or services. In one variant, the answers to these questions are averaged (e.g., according to a simple mathematical average), and a rating is provided. Alternatively, more complex schemes may be applied, such as the use of weighted averages (i.e., one rating or rater given more weight than others, based on some particular attribute such as temporal proximity, particular knowledge or expertise in the field, prior “vetted” history of providing accurate ratings, etc.) and/or moving windows (i.e., to help ensure that old data does not unduly contaminate or skew more recent data, the latter ostensibly being more representative of the current quality, etc.)

### Broker Facilitated Communication—

In another embodiment, the broker platform may be used as a means for providing communication between the various content sources 102, content buyers 106, and/or content editors 108, as well as with the broker 110 itself. The broker platform may be used as a secure means for communicating between the entities regarding the purchase or sale of content and/or services. For example, if a particular buyer 106 generally likes content provided by a particular content source 102, the buyer 106 may utilize the broker 110 platform to send a direct message to the content source 102 requesting that the source generate particular content. For instance, during an event such e.g., the Olympics, the content buyer 106 may specifically request that the content source 102 generate a piece (e.g., video or written article) discussing the background of the U.S. Men's hockey team's star player.

In one variant, the messaging between the entities is performed by e.g., each entity logging into the broker web site and retrieving “mail” stored thereat. Alternatively, the message may be forwarded from the broker website directly to the messaged party.

### Media Content Source—

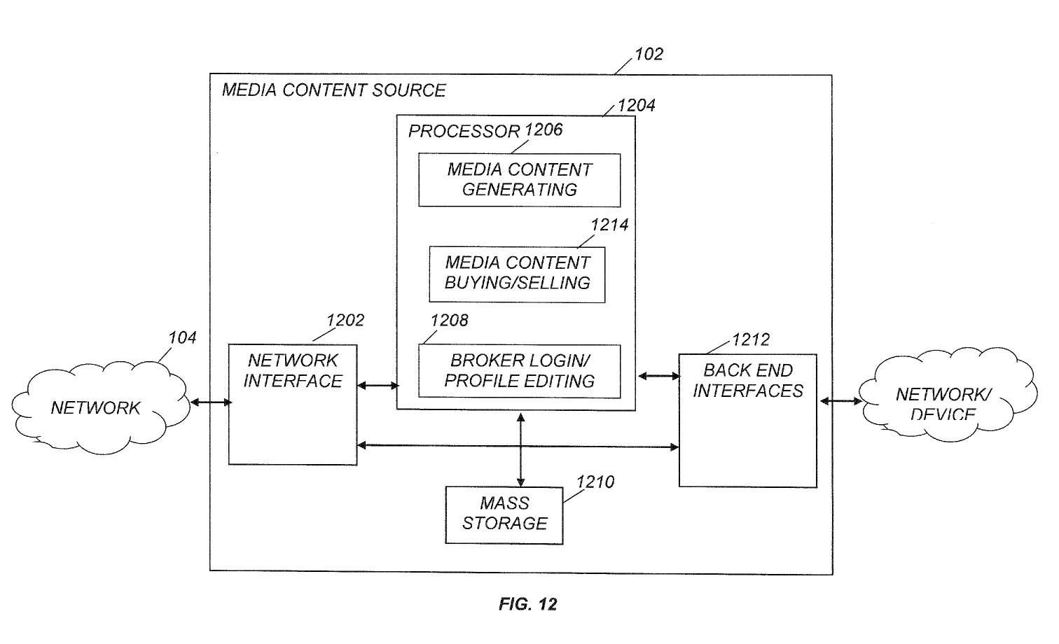

FIG. 12 illustrates an exemplary apparatus for use as a media content source 102. As shown, the device comprises a network interface 1202 for communication with the broker 110 and other entities via the network 104, a processor 1204 and associated storage 1210, and various backend wireline or wireless interfaces 1212 for communication and interface with a user of the device 102 and/or other devices or networks (e.g., PANs, LANs, MANs, cellular, USB, IEEE-1394, DisplayPort, etc.).

In one example, the backend interfaces 1212 may enable a user to connect the content source 102 to another device capable of generating media content. Suppose for example that a user records content on a mobile telephone device. The user may connect the mobile device to the content source apparatus 102 (in one embodiment, a personal computer), and upload the recorded media content to the broker site via the source apparatus 102. In an alternative embodiment, the mobile device may comprise the content source 102, and may directly provide recorded media content to the broker 110.

The processor 1204 of the illustrated embodiment is configured to run one or more of a media content generating application 1206, a media content buying/selling application 1214, and a broker login/profile editing application 1208 thereon. The media content generating application 1206 includes the necessary software for recording, capturing or otherwise creating media content and works in conjunction with hardware needed to accomplish media creation. For example, the media content generating application 1206 may include necessary software to enable a user of the device 102 to generate a news article (e.g., in Microsoft Word®, or other platform). In one alternative, however, the media content generating application 1206 may be located on a device remote to the content source 102; such as in the above example, where the content is generated at a mobile telephone device in communication with a content source 102 (e.g., personal computer).

The media content buying/selling application 1214 enables a user of the content source device 102 to complete buying/selling transactions via the broker 110. The buying/selling application 1214 enables a user to sell assets via the broker by i.e., accepting payment and performing necessary steps for completing payment transactions for content assets. The buying/selling application 1214 further enables a user to buy editing services via the broker by i.e., providing payment for these services to the broker.

The broker login/profile editing application 1208 enables a user of the content source device 102 to login to the broker 110 site. In one embodiment, the application 1208 further comprises necessary software for enabling the user to access a login page maintained by the broker 110, and to make various changes or edits to a profile maintained for the device 102 (or the user) at the broker 110 site. For example, via the login/editing application 1208, a user may login to the broker 110 site and establish that he/she would like to be notified in the event a content buyer 106 is interested in purchasing still photographs of a local news-worthy event.

### Media Content Buyer—

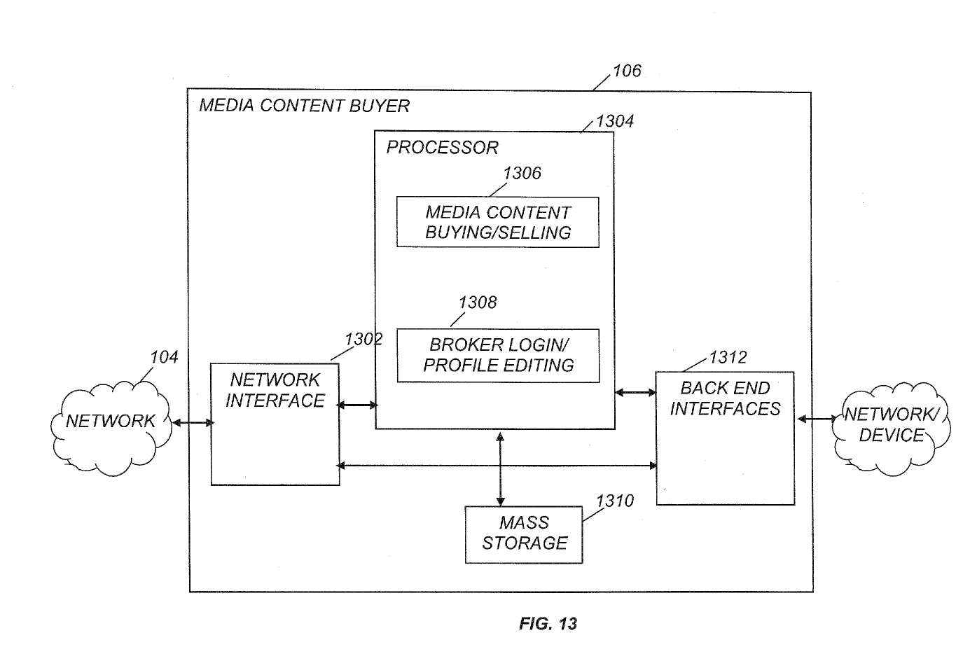

FIG. 13 illustrates an exemplary apparatus for use as a media content buyer 106. As shown, the device comprises a network interface 1302 for communication with the broker 110 and other entities via the network 104, a processor 1304 and associated storage 1310, and various backend interfaces 1312 such as those previously described with respect to FIG. 12 for communication and interface with a user of the device 106 and/or other devices or networks.

In one example, the backend interfaces 1312 may enable a user to connect the content buyer device 106 to another device capable of utilizing purchased media content. For example, a content buyer may purchase media content from the broker 110 on a first personal computer (e.g., buyer device 106), and then distribute the content internally for use by the buyer, such as to a printer for incorporating into print-media, to an in-house editor for incorporating into an audio/video program, etc.

The processor 1304 of the illustrated embodiment is configured to run one or more of a media content buying/selling application 1306 and a broker login/profile editing application 1308 thereon. The media content buying/selling application 1306 enables a user of the media content buyer device 106 to complete buying/selling transactions via the broker 110. The buying/selling application 1306 enables a user to purchase media assets via the broker by i.e., providing payment and performing necessary steps for completing payment transactions for content assets. The buying/selling application 1306 further enables a user to buy editing services via the broker by i.e., providing payment for these services to the broker.

The broker login/profile editing application 1308 enables a user of the content buyer device 106 to login to the broker 110 site. Via the application 1208, the user is able to access a login page maintained by the broker 110, and to make various changes or edits to a profile maintained for the device 106 (or a user of the device) at the broker 110 site. For example, via the login/editing application 1308, a user may login to the broker 110 site and establish that the buyer would like to be notified as soon as content becomes available for purchase regarding a particular current event.

### Media Content Editor—

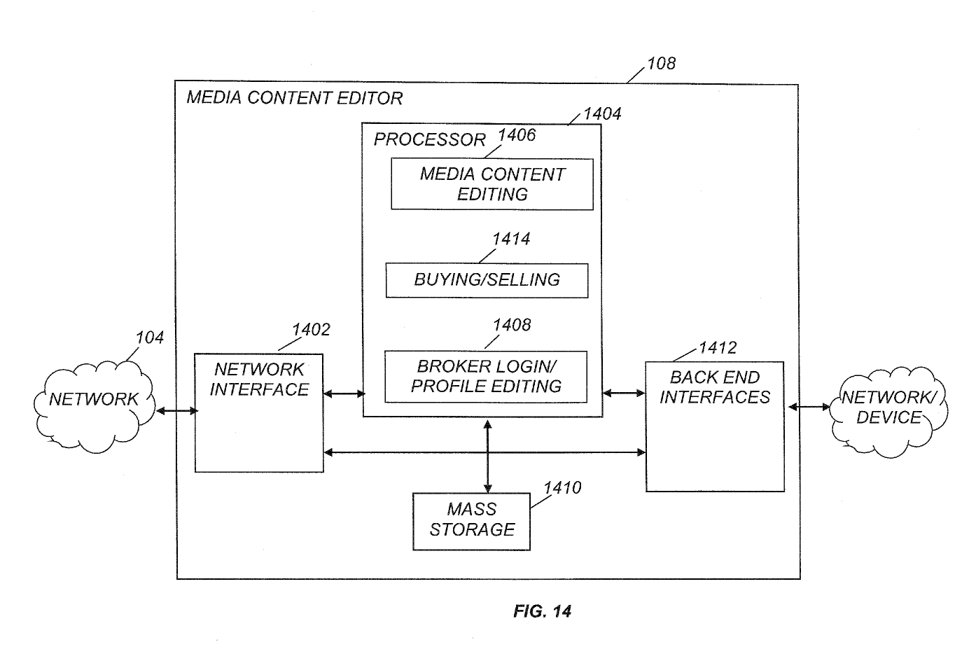

FIG. 14 illustrates an exemplary apparatus for use as a media content editor 108. As shown the device comprises a network interface 1402 for communication with the broker 110 and other entities via the network 104, a processor 1404 and associated storage 1410, and various backend interfaces 1412 of the type previously described for communication and interface with a user of the device 102 and/or other devices or networks.

In one example, the backend interfaces 1412 may enable a user to connect the media editor device 108 to another device capable of editing media content. Suppose for example that audio/video content is to be edited using advanced software available to professional video editors. The content editor 108 receives the unedited content at a first computer apparatus (such as a desktop computer) and subsequently provides the unedited media content to a device for performing the advanced editing techniques via a backend interface 1412. Content may be returned to the editor device 108 once edited via this same interface. In an alternative embodiment, the editing may be performed at the editor device 108.

The processor 1404 of the illustrated embodiment is configured to run at least one of a media content editing application 1406, a media content buying/selling application 1414, and/or a broker login/profile editing application 1408 thereon. The media content editing application 1406 includes the necessary software for editing media content and works in conjunction with hardware needed to accomplish media editing. For example, the media content editing application 1406 may include necessary software to enable a user of the device 108 to view and make changes to a news article (e.g., in Microsoft Word®, or other platform).

In one alternative, however, the media content editing application 1406 may be located on a device remote to the content editor device 108; such as in the above example, where the content is edited via advance editing equipment in communication with a the content editor device 108 (e.g., desktop computer).

The media content buying/selling application 1414 enables a user of the content editing device 108 to complete buying/selling transactions via the broker 110. The buying/selling application 1414 enables a user to sell editing services via the broker 110 by i.e., accepting payment and performing necessary steps for completing payment transactions for content assets.

The broker login/profile editing application 1408 enables a user of the content editor device 108 to login to the broker 110 site, access a login page maintained by the broker 110, and to make various changes or edits to a profile maintained for the device 108 (or the user of the device) at the broker 110 site. For example, via the login/editing application 1408, a content editor may establish and/or change the editing service which are provided thereby.

### Broker—

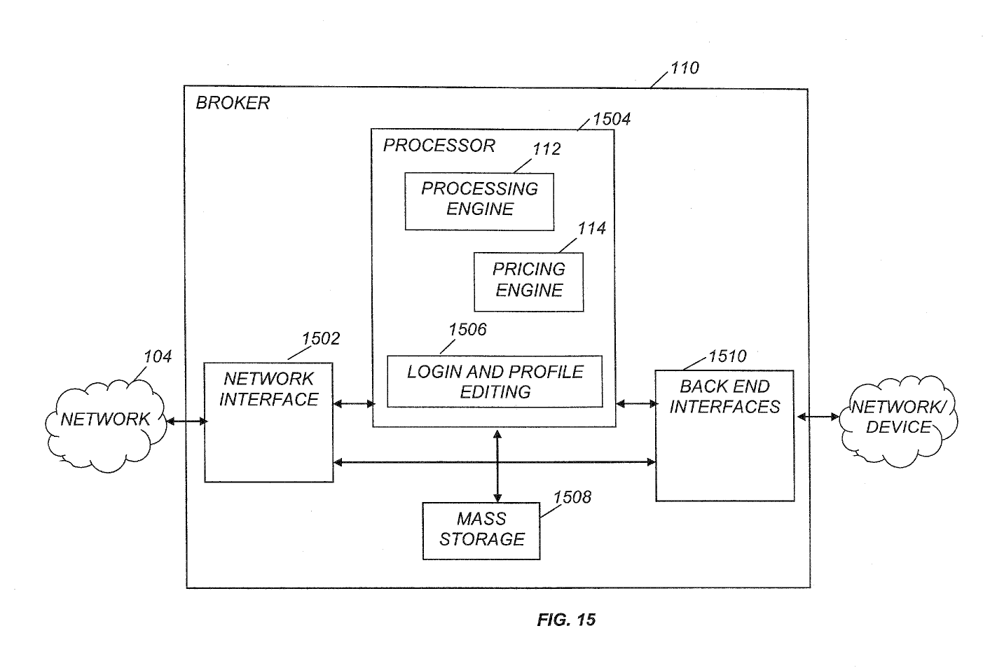

FIG. 15 illustrates an exemplary apparatus for use as a media content broker 110. As shown the device comprises a network interface 1502 for communication with the content source 102, content buyer 106, and content editor 108 entities via the network 104, a processor 1504 and associated storage 1508, and various backend interfaces 1510 of the type previously described herein for communication and interface with other devices and/or networks.

The processor 1504 is configured to run at least one of a processing engine 112, a pricing engine 114, and/or a login and profile editing application 1506 thereon. The processing engine 112 may be utilized to perform various processes discussed herein. For example, the processing engine 112 utilizes data input by the content source 102 and/or the content buyer 106 (such as content describers and/or search criteria) to generate a list of one or more news content items to be displayed to the buyer 106 for purchase. Transactions performed between the content source 102, content buyer 106, editor 108, and broker 110 are facilitated by the processing engine 112. The processing engine 112 may also be utilized to provide notifications to these entities regarding available content, completed transactions, etc. Content processing may also be performed by the processing engine 112, such as assigning an identification number to the content and a time stamp on the submission.

The pricing engine 114 is primarily utilized to provide reduced pricing services as discussed in FIGS. 6-8 above. The pricing engine 114 may also be utilized to facilitate payment transactions between the content source 102, content buyer 106, content editor 108 and broker 110.

The login and profile editing application 1506 provides various interfaces by which users of the content source device 102, content buyer device 106, and content editor device 108 may establish and edit profiles maintained at the broker 110 (e.g., in storage thereon). The login and profile editing application 1506 provides various options relating to default parameters established for each unique identity.

Many other approaches and combinations of various operational and business paradigms are envisaged consistent with the invention, as will be recognized by those of ordinary skill when provided this disclosure.

It will be recognized that while certain aspects of the invention are described in terms of a specific sequence of steps of a method, these descriptions are only illustrative of the broader methods of the invention, and may be modified as required by the particular application. Certain steps may be rendered unnecessary or optional under certain circumstances. Additionally, certain steps or functionality may be added to the disclosed embodiments, or the order of performance of two or more steps permuted. All such variations are considered to be encompassed within the invention disclosed and claimed herein.

While the above detailed description has shown, described, and pointed out novel features of the invention as applied to various embodiments, it will be understood that various omissions, substitutions, and changes in the form and details of the device or process illustrated may be made by those skilled in the art without departing from the invention. The foregoing description is of the best mode presently contemplated of carrying out the invention. This description is in no way meant to be limiting, but rather should be taken as illustrative of the general principles of the invention. The scope of the invention should be determined with reference to the claims.

What is claimed is:

1. A method for exchanging of media content via a network, said method comprising:
uploading media content from a content source to a media content server associated with a content broker;
making said media content available for acquisition by one or more media content acquirers;
receiving a selection of said media content from at least one of said one or more media content acquirers; and
providing said media content thereto.

2. The method of claim 1, wherein said acquisition comprises purchase, and said method further comprises distributing a first portion of a received payment to said content source, with a remaining portion being retained by said content broker.

3. The method of claim 1, wherein said method further comprises:
issuing a request for a particular type of media content; and
substantially in response to said issued request, receiving a request from said content source to upload said media content.

4. The method of claim 1, further comprising processing said media content.

5. The method of claim 4, wherein said processing of said media content comprises validating one or more parameters of said media content.

6. The method of claim 5, wherein said one or more parameters comprise parameters entered by said content source regarding one or more aspects of said media content.

7. The method of claim 4, wherein said processing of said media content comprises assigning an identification number and time stamp to said media content.

8. The method of claim 1, wherein said making said media content available for acquisition by one or more media content acquirers comprises making said media content available via a network user interface maintained by said content broker.

9. The method of claim 1, wherein said act of making said media content available for acquisition comprises notifying individual ones of said one or more media content buyers of an availability of said media content.

10. The method of claim 1, further comprising utilizing one or more parameters for pricing said media content, said parameters indicating a sale price for said content and one or more amounts and associated times for reducing said sale price.

11. The method of claim 1, further comprising enabling said content source or said content buyer to purchase editing services, said editing services performed by a content editor.

12. The method of claim 1, further comprising enabling said content buyer to select an indicator of quality of said content.

13. The method of claim 12, wherein said content is provided for subsequent purchase, said indicator of said quality of said content being displayed therewith.

14. A non-transitory computer readable apparatus having a storage medium and being adapted to store at least one computer program thereon, said at least one computer program enabling the exchange of content in a network, the computer program being configured to, when executed:
process said content uploaded from a user device, said content comprising content generated by a user of said user device;
provide an interface for enabling at least one of a plurality of content buyers to select said content for purchase;
provide a mechanism for receiving payment from said at least one of said plurality of content buyers in exchange for providing said content thereto; and
divide said payment into at least first and second portions, said first portion distributed to said user, and said second portion distributed to a content broker;
wherein said broker comprises an entity maintaining said computer readable apparatus in association with a networked server.

15. The computer readable apparatus of claim 14, wherein said content comprises newsworthy subject matter.

16. The computer readable apparatus of claim 14, wherein said content comprises content related to one or more current news topics.

17. The computer readable apparatus of claim 14, wherein said plurality of content buyers comprise buyers registered to said broker via establishment of a buyer account.

18. The computer readable apparatus of claim 17, wherein said establishment of said buyer account comprises enablement of each of said plurality of buyers to enter one or more parameters for desired content.

19. The computer readable apparatus of claim 18, wherein:
said processing of said content uploaded from said user device comprises identification of said content as having said one or more parameters entered by at least one of said plurality of buyers; and
said computer program is further configured to, when executed, notify said at least one of said plurality of buyers of the availability of said content meeting said one or more parameters.

20. The computer readable apparatus of claim 14, wherein said computer program is further configured to, when executed, implement a mechanism for reducing a sale price of said content over time.

21. The computer readable apparatus of claim 20, wherein said sales price is reduced according to parameters entered by said user for percentage reductions and time periods for said percentage reductions.

22. The computer readable apparatus of claim 14, wherein said computer program is further configured to, when executed, provide an interface for enablement of at least one of said user or said content buyer to purchase editing services for said content.

23. A method of providing price adjustments of a sales price of purchasable content as a function of time, said method comprising:
receiving said content from a first user;
receiving at least one parameter from said first user for the pricing of said content, said at least one parameter indicating at least one time interval during which said content may be offered for sale at a sales price before a price reduction is enacted;
offering said content for sale to second users at said sales price;
after expiration of said time interval:
performing said price reduction; and
offering said content for sale to said second users at a second price which is reduced from said sales price.

24. The method of claim 23, wherein:
Said at least one parameter further comprises a minimum sales price, a maximum sales prices, and a percentage of reduction;
said method further comprises continuing to perform said price reduction until said second price is equal to or less than said minimum sales price; and
if said second price is less than said minimum sales price, offering said content at said minimum sales price indefinitely.

25. The method of claim 23, wherein said sales price comprises a maximum sales price.

26. The method of claim 23, wherein said content comprises content generated by said first user and related to a newsworthy event.

27. The method of claim 23, further comprising:
receiving a selection of said content from at least one of said second users;
upon receiving payment from said at least one of said second users, providing said content thereto; and
distributing a first portion of said payment to said first user, a remaining portion being kept by a content broker.

28. The method of claim 27, further comprising, in response to said act of receiving a selection of said content from at least one of said second users, providing said at least one of said second users an opportunity to purchase editing services for said content.

29. The method of claim 23, farther comprising, in response to said act of receiving said content from a first user, providing said first user an opportunity to purchase editing services for said content.

30. A non-transitory computer readable apparatus having a storage medium and being adapted to store at least one computer program thereon, said at least one computer program which enables the adjustment of a sale price of purchasable content as a function of time, the computer program which is configured to, when executed:
receive a plurality of parameters for pricing of said content from a user which generated said content;
utilize said plurality of parameters to calculate a sales price of said content, said sales price being based at least in part on a time during which said content has been offered for sale; and
offer said content for sale to at least one buyer at said sales price.

31. The computer readable apparatus of claim 30, wherein said parameters include information indicating:
a maximum sales price;
a minimum sales price;
a percentage by which said sales price may be reduced; and
at least one time interval during which said content may be offered for sale a said sales price before a price reduction is calculated.

32. The computer readable apparatus of claim 31, wherein said calculation of said sales price comprises reducing a first sales price by said percentage at the expiration of said time interval.

33. The computer readable apparatus of claim 31, wherein said computer program is further configured to:
continue to perform said price reduction at said time intervals until said sales price is equal to or less than said minimum sales price; and
if said sales price is less than said minimum sales price, offer said content at said minimum sales price indefinitely.

34. The computer readable apparatus of claim 30, wherein said content comprises user-generated content related to a newsworthy event.

35. The computer readable apparatus of claim 30, wherein said compute program is further configured to:
receive a selection of said content from said at least one buyer;
receive payment of said sales price from said at least one buyer;
distribute said content to said at least one buyer; and
distribute a portion of said payment to said user which generated said content.

36. The computer readable apparatus of claim 35, further comprising, in response to receipt of said selection of said content from said at least one buyer, providing said at least one buyer an opportunity to have said content edited for an additional fee.

37. The computer readable apparatus of claim 30, wherein said computer program is further configured to offer said user an opportunity to have said content edited for by an editor service in exchange for payment.

38. A method of providing media content editing services over a network, said method comprising:
uploading media content from a media content source to a media content server associated with a media content broker for the sale thereof;
identifying one or more media content editing service providers providing media content editing services applicable to said media content;
receiving a selection of at least one of said one or more media content editing service providers;
providing said media content to a selected one of said one or more media content editing service providers for editing thereof;
establishing an account for holding payment for said media content editing services; and
upon completion of said editing of said media content:
releasing at least a portion of said payment to said selected one of said one or more media content editing service providers; and
providing said edited media content.

39. The method of claim 38, further comprising processing said media content, said identification of said one or more editing service providers being based at least in part on said act of processing.

40. The method of claim 38, wherein said selection of said at least one of said one or more media content editing service providers is performed by said media content source.

41. The method of claim 38, further comprising making said media content available for purchase by a plurality of media content buyers via an interface maintained by said content broker.

42. The method of claim 41, wherein said selection of said at least one of said one or more media content editing service providers is performed by said at least one of said plurality of media content buyers.

43. A non-transitory computer readable apparatus having a storage medium and being adapted to store at least one computer program thereon, said at least one computer program enabling provision of media content editing services over a network, the computer program which is configured to, when executed:
identify one or more editing service providers providing editing services applicable to an individual one of a plurality of media content;
enable a user to select at least one of said one or more editing service providers with respect to said individual one of said plurality of media content;
provide said individual one of said plurality of media content to said selected at least one of said one or more editing service providers;
distribute at least a portion of payment for said media content editing services to said selected at least one of said one or more editing service providers; and
distribute an edited version of said media content, said edited version being processed by said selected at least one of said one or more editing service providers.

44. The apparatus of claim 43, wherein said computer program is further configured to enable a purchaser of said editing services to provide one or more indicia regarding said purchaser's satisfaction with said editing services.
